(19) United States
(12) Patent Application Publication
(10) Pub. No.: US 2008/0104511 A1
(43) Pub. Date: May 1, 2008

(54) Automatic software application menu generation

(75) Inventors: Manokar Chinnadurai, Owatonna, MN (US); Corneliu Boac, Farmington, MN (US); Aaron Canny, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/808,304

(22) Filed: Jun. 8, 2007

Related U.S. Application Data
(60) Provisional application No. 60/855,141, filed on Oct. 30, 2006.

(51) Int. Cl. G06F 3/00

(52) U.S. Cl. 715/703; 715/700

(57) ABSTRACT

A method and apparatus are provided that allow for automatic applications menu generations when an updated application is available to a vehicle diagnostic device. The applications are verified to ensure that they are authorized for the vehicle diagnostic device. Templates can be used to generate the applications menu by associating the template with the installed application. The vehicle diagnostic device can display the applications menu and sort the applications menu based authorized applications versus unauthorized applications.

### CROSS-REFERENCE TO RELATED APPLICATIONS

This application claims priority to provisional U.S. patent application entitled, “AUTOMATIC SOFTWARE APPLICATION MENU GENERATION,” filed Oct. 30, 2006, having a Ser. No. 60/855,141, now pending, the disclosure of which is hereby incorporated by reference, in its entirety.

### FIELD OF THE INVENTION

The present invention relates generally to a software updating process. More particularly, the present invention relates to automatic software application menu generation for a vehicle diagnostic device.

### BACKGROUND OF THE INVENTION

Vehicle diagnostic device, such as scan tools are used to diagnosis problems with a vehicle. The scan tool is linked to the vehicle's computer via a data link connector (DLC). Once linked, the scan tools can query the vehicle's computers or electronic control units (ECUs) with the appropriate vehicle communication protocols and collect vehicle diagnostic data. Once collected, the diagnostic data can be displayed on the display so that a technician can make the appropriate diagnosis.

Software applications on the scan tool allow the scan tool to diagnosis the vehicle. The software can include applications to diagnose vehicles from various manufacturers, including manufactures from various countries. Information about the vehicles operating parameters, various fault codes, various ECUs in the car, test procedures, schematics, diagrams and other information are contained in the software. This software is updated periodically, such as yearly or every other year. The user normally loads all the applications that can be utilized by the scan tool, such as USA domestic 2005, Asian 2005, European 2005, and ABS/Airbag 2004 (all available from Service Solutions, a division of the SPX Corporation), into a memory device, such as a CF (compact flash) card that is coupled to a computing device, such as a personal computer. Then the memory device is inserted into a card reader of the scan tool and the applications can be accessed by the scan tool. Then the scan tool verifies if some or all of the software applications are authorized for that scan tool. If the applications are not authorized, then the icons for those applications may not appear or appear but “grey” out on an applications menu displayed on the scan tool. The applications menu is generated from a database that is source code driven and has to be “rebuilt” every time updated applications are added to the scan tool. Thus, each time an application is updated the source code for the applications menu generation has to be rewritten and has to be validated. Rewriting source code can cause errors on the applications menu, such as missing application icons or having icons that are not linked to the applications. Additionally, validation of source code requires extensive manpower and time for testing and retesting.

Accordingly, it is desirable to provide a process that does not require validation of the software or source code that is rewritten each time an updated application is available.

### SUMMARY OF THE INVENTION

The foregoing needs are met, to a great extent, by the present invention, wherein in one aspect a method is provided that in some embodiments allows for automatic menu generation via templates based on the configuration files and rule tags presented in the template files instead of rewriting source codes when an updated application is added to the scan tool.

In accordance with one embodiment of the present invention, a method to generate an applications menu on a vehicle diagnostic device is provided and can include determining the applications that are installed on the vehicle diagnostic device, parsing a template from a template file for each of the installed applications, verifying authorized applications installed on the vehicle diagnostic device, assembling relevant templates of installed applications, generating the applications menu with the relevant templates, wherein the applications menu is generated automatically when a new application is installed on the vehicle diagnostic device, and displaying the generated applications menu on a display of the vehicle diagnostic device.

In accordance with another embodiment of the present invention, a computer readable storage medium having associated data, when accessed, results in a machine performing the following steps: determining the applications that are installed on the vehicle diagnostic device, parsing a template from a template file for each of the installed applications, verifying authorized applications installed on the vehicle diagnostic device, assembling relevant templates of authorized applications, generating the applications menu with the relevant templates, wherein the applications menu is generated automatically when a new application is installed on the vehicle diagnostic device, and displaying the generated applications menu on a display of the vehicle diagnostic device.

In accordance with yet another embodiment of the present invention, a system for generating an applications menu on a vehicle diagnostic device is provided and can include means for determining the applications that are installed on the vehicle diagnostic device, means for parsing a template from a template file for each of the installed applications, means for verifying authorized applications installed on the vehicle diagnostic device, means for assembling relevant templates of installed applications, means for generating the applications menu with the templates, wherein the applications menu is generated automatically when a new application is installed on the vehicle diagnostic device, and means for displaying the generated applications menu on a display of the vehicle diagnostic device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a scan tool that can use the automatic menu generation method according to an embodiment of the invention.

FIG. 2 is a block diagram of the components of the scan tool of FIG. 1.

FIG. 3 illustrates representative applications and respective icons that are available to the scan tool.

FIG. 4 is a flowchart for the automatic application menu generation software according to an embodiment of the present invention.

### DETAILED DESCRIPTION

The invention will now be described with reference to the drawing figures, in which like reference numerals refer to like parts throughout. An embodiment in accordance with the present invention allows the scan tool to automatically generate an applications menu via templates when updated or new applications are loaded on the scan tool. The scan tool can be any computing device, such as a telephone, personal digital assistant, a notebook, or desktop that connects to a vehicle and retrieves diagnostic data from the vehicle. Each of these computing devices can use an application menu to launch an application.

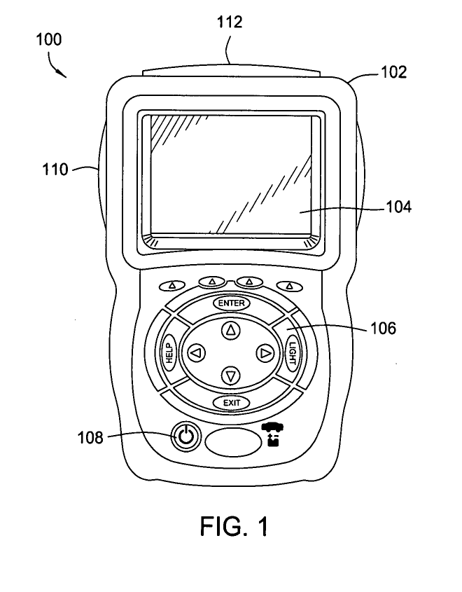

FIG. 1 is a front view of a scan tool 100 that can use the automatic applications menu generation method according to an embodiment of the invention. The scan tool 100 can be any computing device, such as, for example, the Nemisys scan tool from Service Solutions (a unit of the SPX Corporation) in Owatonna, Minn. The scan tool 100 includes a housing 102 to house the various components of the scan tool, such as a display 104, a user interface 106, a power key 108, a memory card reader 110 and a connector interface 112. The display 104 can be any display, for example, LCD (liquid crystal display), VGA (video graphics array), touch display (can also be a user interface), etc. The user interface 106 allows the user to interact with the scan tool in order to operate the scan tool as desired. The user interface 106 can include function keys, arrow keys or any other type of keys that can manipulate the scan tool 100 in order to operate various menus that are presented on the display including the applications menu. The input device 106 can also be a mouse or any other suitable input device, including a keypad. The user interface 106 can also include numbers or be alphanumeric. The power key 108 allows the user to turn the scan tool 100 on and off, as required.

Memory card reader 110 can be a single type card reader, such as a compact flash card, floppy disc, memory stick, secure digital, other types of flash memory or other types of memory. The software updates stored on a flash memory can be inserted into the memory card reader 110 in order to load the software updates on the scan tool. The memory card reader 110 can be a reader that reads more than one of the aforementioned memory such as a combination memory card reader. Additionally, the card reader 110 can also read any other computer readable medium, such as CD, DVD, UMD, etc.

The connector interface 112 allows the scan tool 100 to connect to an external device, such as an ECU (electronic control unit) of a vehicle through the adaptive cable described herein, a computing device, an external communication device (such as a modem), a network, etc. through a wired or wireless connection. Connector interface 112 can also include a USB, FIREWIRE, modem, RS232, RS48J, and other connections to communicate with external devices, such as a hard drive, USB flash memory device, CD player, DVD player, UMD player or other computer readable medium devices.

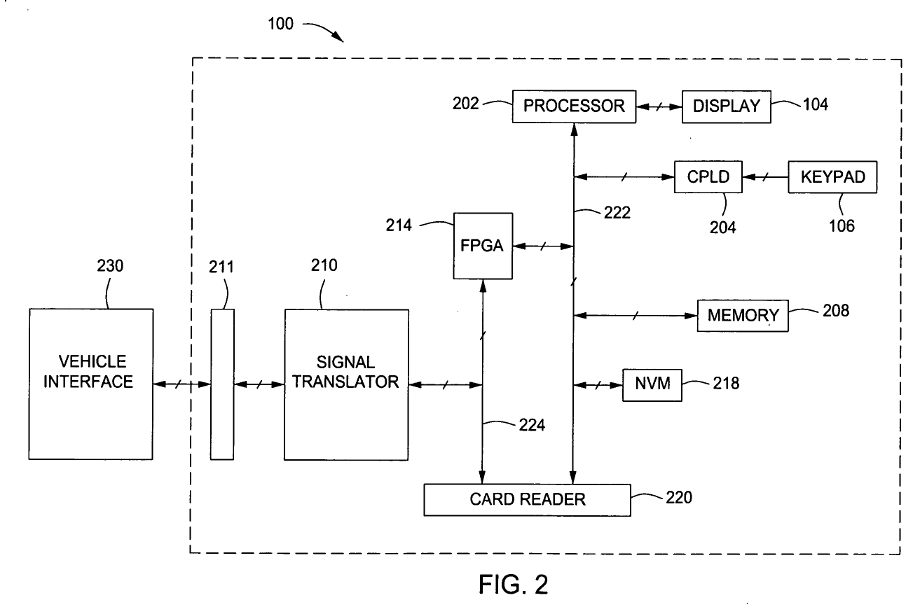

FIG. 2 is a block diagram of the components of the scan tool 100 of FIG. 1. In FIG. 2, the scan tool 100 according to an embodiment of the invention includes a processor 202, a field programmable gate array (FPGA) 214, a first system bus 224, the display 104, a complex programmable logic device (CPLD) 204, the user interface in the form of a keypad 106, a memory subsystem 208, an internal non-volatile memory 218, a card reader 220, a second system bus 222, a connector interface 211, and a selectable signal translator 210. A vehicle communication interface 230 is in communication with the scan tool 100 through connector interface 211 via an external cable (not shown).

Selectable signal translator 210 communicates with the vehicle communication interface 230 through the connector interface 211. Signal translator 210 conditions signals received from an ECU unit through the vehicle communication interface 230 to a conditioned signal compatible with scan tool 100. Signal translator 210 can communicate with, for example, the following communication protocols: J1850 (VPM and PWM), ISO 9141-2 signal, communication collision detection (CCD) (e.g., Chrysler collision detection), data communication links (DCL), serial communication interface (SCI), S/F codes, a solenoid drive, J1708, RS232, Controller Area Network (CAN), Keyword 2000 (ISO 14230-4) or other communication protocols that are implemented in a vehicle.

The circuitry to translate and send in a particular communication protocol can be selected by FPGA 214 (e.g., by tri-stating unused transceivers) or by providing a keying device that plugs into the connector interface 211 that is provided by scan tool 100 to connect scan tool 100 to vehicle communication interface 230. Signal translator 210 is also coupled to FPGA 214 and the card reader 220 via the first system bus 224. FPGA 214 transmits to and receives signals (i.e., messages) from the ECU unit through signal translator 210.

The FPGA 214 is coupled to the processor 202 through various address, data and control lines by the second system bus 222. FPGA 214 is also coupled to the card reader 220 through the first system bus 224. The processor 202 is also coupled to the display 104 in order to output the desired information to the user. The processor 202 communicates with the CPLD 204 through the second system bus 222. Additionally, the processor 202 is programmed to receive input from the user through the user interface 106 via the CPLD 204. The CPLD 204 provides logic for decoding various inputs from the user of scan tool 100 and also provides glue-logic for various other interfacing tasks.

Memory subsystem 208 and internal non-volatile memory 218 are coupled to the second system bus 222, which allows for communication with the processor 202 and FPGA 214. Memory subsystem 208 can include an application dependent amount of dynamic random access memory (DRAM), a hard drive, and/or read only memory (ROM). Software that operates the basic functions of the scan tool 100 can be stored in the memory subsystem 208, while the software to operate the diagnostic functions of the scan tool can be stored on an external memory device, such as a CF card. In one embodiment, the diagnostic software can be loaded onto the internal memory of the scan tool.

Internal non-volatile memory 218 can be an electrically erasable programmable read-only memory (EEPROM), flash ROM, or other similar memory. Internal non-volatile memory 218 can provide, for example, storage for boot code, self-diagnostics, various drivers and space for FPGA images, if desired. If less than all of the modules are implemented in FPGA 214, memory 218 can contain downloadable images so that FPGA 214 can be reconfigured for a different group of communication protocols.

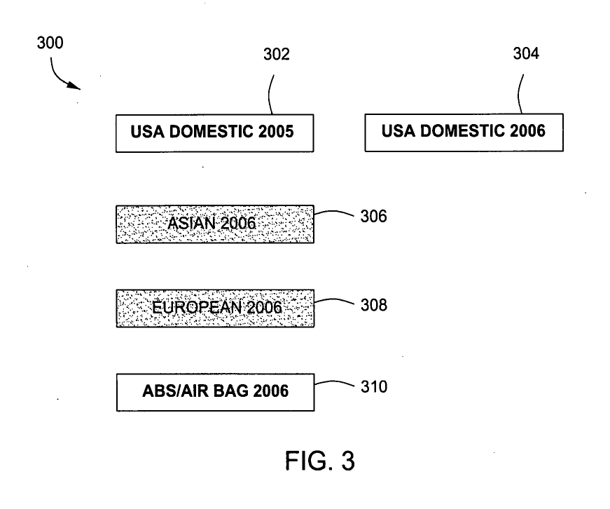

FIG. 3 illustrates representative applications 300 and respective icons that are available to the scan tool. Once the applications are loaded, the scan tool can check to see what version of the applications the scan tool is authorize for. The scan tool can check the application authorization based on a security card that can be supplied with the software. The security card will only allow access to the authorized version of that software. Such security card system is disclosed in U.S. Pat. No. 7,050,892 assigned to SPX Corporation and is incorporated herein in its entirety. Other methods of authorization are contemplated including authorization through telephonic or web-based means.

The software includes application that requires automatic menu generation. As shown in FIG. 3, the applications include USA DOMESTIC 2005 (302), USA DOMESTIC 2006 (304), ASIAN 2006 (306), EUROPEAN 2006 (308), and ABS/AIRBAG 2006 (310). The authorized applications are shown as normal and unauthorized applications are shown in “grey.” Thus, in this example, authorized applications are ABS/AIRBAG 2006, USA DOMESTIC 2005 and USA DOMESTIC 2006. USA DOMESTIC 2006 is the updated application and requires an automatic applications menu generation. ASIAN 2006 (306) and EUROPEAN 2006 (308) applications are not authorized for this scan tool. The applications menu can be generated each time new applications are updated, modified or become unauthorized.

The templates file can include templates that are written for the specified applications and any available applications. The template files can be pulled into an applications menu file (discussed below). When new applications are added, modified or updated, the templates can be used to generate the icons and the applications menu. The template can be written for specific applications and can be simply added to the file containing other templates. Because the templates are written when applications are added, modified or updated and do not affect other templates, then errors that may occur in the new templates will be isolated to those templates and not to the entire templates file. Previously, errors that occur while rewriting the source code for the new application can become parts of the source code and errors on the applications menu can occur. Additionally, by using templates, it is easier to find errors in the template than in the source code because the templates are smaller in size than the source code. Thus, any errors are isolated to each individual template or sets of templates for the update application and can easily be fixed. Below are examples of template files for the USA Domestic 2006 application:

### <PF06> USA 2006 Domestic “/spx/icons/“Domestic”

### <PF06> GM Domestic “/spx/icons/“GM”

### <PF06> Chrysler Domestic “/spx/icons/“Chrysler”

### <PF06> Saturn Domestic “/spx/icons/“Saturn”

### <PF06> Ford Domestic “/spx/icons/“Ford”

### <PF06> Jeep Domestic “/spx/icons/“Jeep”

The template can use headers such as “<PF06>” to designate which application the template is for. The remaining part of the template are design to help the menu file generate the correct icon on the application menu.

The templates are then pulled into the application menu file where the other templates are present. For example, the templates for the other previously authorized applications, such as shown in FIG. 3 (ABS/AIRBAG 2006, USA DOMESTIC 2005) are already present in the application menu file. Thus, the application menu generation software will pull the appropriate templates for authorized applications into the application menu file and optionally leave the unauthorized templates in the templates file. Thus, the menu file will contain the necessary templates to generate the application menu.

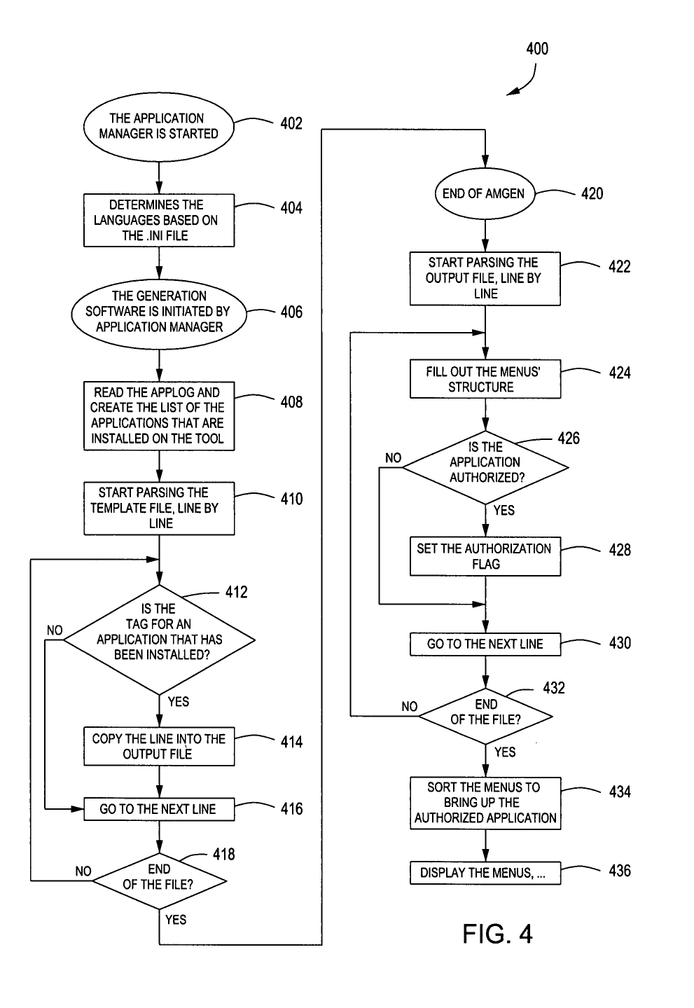

FIG. 4 is a flowchart 400 for the automatic application menu generation software according to an embodiment of the present invention. At step 402, the application manager is started. The application manager includes application menu generation software (generation software) or module. At step 404, the application manager determines the language the scan tool is running based on the .ini file. The languages that the scan tool can support include English, Spanish, German and other languages. At step 406, the application manager initiates the generation software. The generation software reads the application log, at step 408, to determine which applications are authorized for the scan tool, as previously described.

At step 410, the generation software starts to parse the templates file, line by line. The templates file contains all of the templates for all available applications for the scan tool. At step 412, the generation software determines if the line tag or header is for the updated application. If yes, then the generation software proceeds to step 414, where the current line tag is copied and appended to an output file and then the generation software proceeds to step 416. If no, then the generation software proceeds to step 416. At step 416, the generation software proceeds to the next line, and then to step 418. At step 418, the generation software determines if it is at the end of the templates file or if all the templates have been reviewed for relevancy to the new application. If no, then the generation software proceeds back to step 412. If yes, then the generation software ends at step 420 where the generation software ends, but the application manager continues.

The application manager then proceeds to step 422, where the application manager starts to parse out the output file, line by line. At step 424, the menu structure is filled out with the appropriate template. At step 426, the application manager again checks to see if the updated application is authorized. The application manager can also verify if the other loaded applications are authorized. If yes, then the application manager proceeds to step 428, where a flag can be set and then proceeds to step 430. If no, then the software proceeds to step 430. At step 430, the application manager proceeds to the next line. At 432, the application manager determines if the end of the output file has been reached. If yes, the application manager proceeds to step 434, where authorized applications are moved to the beginning of the menu, while the unauthorized applications are moved to the end of the menu. The unauthorized menu can have a “lock” over the icon and/or the icon can be “grey” out. The finalized menu is displayed at step 436. If no at step 432, then the application manager proceeds back to step 424.

The application manager can be used to automatically generate applications menu when a new, modified, or updated application is available to the scan tool The software can detect when a new application is available to the scan tool and retrieve the appropriate templates to generate the applications menu. The software can rebuild the applications menu from “scratch” and reverify which applications are authorized on the scan tool. Alternatively, the software can detect when a new application is present and then only adds that template for that application. The menu generation can be done with minimal or no user interaction. The applications menu can be generated without having to rewrite source code or validate source code. This method will save the software writer precious time from debugging the code and thus allows him to work on other issues that are more pressing for him. The method will also decrease errors in the applications menu and thus saving time to the user because he does not have to reload software fixes due to source code errors related to the applications menu.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method to generate an applications menu on a vehicle diagnostic device, comprising:
determining the applications that are installed on the vehicle diagnostic device;
parsing a template from a template file for each of the installed applications;
verifying authorized applications installed on the vehicle diagnostic device;
assembling relevant templates of installed applications;
generating the applications menu with the relevant templates, wherein the applications menu is generated automatically when a new application is installed on the vehicle diagnostic device; and
displaying the generated applications menu on a display of the vehicle diagnostic device.

2. The method of claim 1, wherein the relevant templates are authorized applications on the vehicle diagnostic device.

3. The method of claim 1 further comprising sorting the application templates so that authorized applications are shown earlier on the menu then unauthorized applications.

4. The method of claim 1 further comprising copying each of the templates of each of the installed applications to an output file.

5. The method of claim 1 further comprising detecting language being used on the vehicle diagnostic device and parsing the template files for the appropriate application and for the detected language.

6. The method of claim 1, wherein verifying authorized application via a security card system.

7. The method of claim 1, wherein the assembling of the templates is based on a header associated with the templates.

8. A computer readable storage medium having associated data, when accessed, results in a machine performing:
determining the applications that are installed on the vehicle diagnostic device;
parsing a template from a template file for each of the installed applications;
verifying authorized applications installed on the vehicle diagnostic device;
assembling relevant templates of authorized applications;
generating the applications menu with the relevant templates, wherein the applications menu is generated automatically when a new application is installed on the vehicle diagnostic device; and
displaying the generated applications menu on a display of the vehicle diagnostic device.

9. The storage medium of claim 8, wherein the relevant templates are authorized applications on the vehicle diagnostic device.

10. The storage medium of claim 8 further comprising sorting the applications so that authorized applications are shown earlier on the menu then unauthorized applications.

11. The storage medium of claim 8 further comprising copying each of the templates of each of the installed applications to an output file.

12. The storage medium of claim 8 further comprising detecting language being used on the vehicle diagnostic device and parsing the template files for the appropriate application and for the detected language.

13. The storage medium of claim 8, wherein verifying authorized application via a security card system.

14. The storage medium of claim 8, wherein the assembly of the templates is based on a header associated with the templates.

15. A system for generating an applications menu on a vehicle diagnostic device, comprising:
means for determining the applications that are installed on the vehicle diagnostic device;
means for parsing a template from a template file for each of the installed applications;
means for verifying authorized applications installed on the vehicle diagnostic device;
means for assembling relevant templates of installed applications;
means for generating the applications menu with the templates, wherein the applications menu is generated automatically when a new application is installed on the vehicle diagnostic device; and
means for displaying the generated applications menu on a display of the vehicle diagnostic device.

16. The system of claim 15, wherein the relevant templates are authorized applications on the vehicle diagnostic device.

17. The system of claim 15 further comprising means for sorting the applications so that authorized applications are shown earlier on the menu then unauthorized applications.

18. The system of claim 15 further comprising means for copying each of the templates of each of the installed applications to an output file.

19. The system of claim 15 further comprising means for detecting language being used on the vehicle diagnostic device and parsing the template files for the appropriate application and for the detected language.

20. The system of claim 15, wherein verifying authorized application via a security card system.

21. The system of claim 15, wherein the assembly of the templates is based on a header associated with the templates.
